(19) United States
(12) Patent Application Publication
(10) Pub. No.: US 2011/0179624 A1
(43) Pub. Date: Jul. 28, 2011

(54) ANIMATED ASSEMBLY SYSTEM

(75) Inventor: James S. Sexton, San Ramon, CA (US)

(73) Assignee: Z-Line Designs, Inc., San Ramon, CA (US)

(21) Appl. No.: 12/694,227

(22) Filed: Jan. 26, 2010

(51) Int. Cl. B23P 11/00

(52) U.S. Cl. 29/428

(57) ABSTRACT

A method for assembling furniture provided in an unassembled kit is provided. A 3D inventory of parts of an unassembled kit of furniture from assembly instructions is displayed on an electronic display. A plurality of 3D animated steps for assembling the furniture is then displayed. The steps are displayed according to respective time periods for completing the respective steps according to an average assembler's assembly ability.

### BACKGROUND OF THE INVENTION

This invention generally relates to instructions for assembly of a kit, and more specifically relates to animated instructions for assembly of kit furniture.

Furniture is often provided in a ready-to-assemble (RTA) form (i.e. in an unassembled kit) for the end purchaser to assemble on their own. Providing furniture in this manner allows for lower prices, as the cost of assembling the furniture is removed from the final purchase price. However, a negative association with RTA furniture may exist due to difficulties in assembly.

RTA furniture is generally provided with instructions. However, the instructions may be poorly implemented due to requirements for multiple languages, as these languages may be poorly translated. The instructions may also be presented in poor visual context, for example by showing blown-up views with no contextual relationship to the rest of the assembly. Accordingly, some purchasers will forgo the cost savings of RTA furniture due to these difficulties.

### BRIEF SUMMARY OF THE INVENTION

An embodiment of the invention provides a method for assembling furniture provided in an unassembled kit. A 3D inventory of parts of an unassembled kit of furniture may be displayed from assembly instructions on an electronic display. The unassembled kit of furniture and assembly instructions may be provided to an average assembler. A 3D animated first step for assembly of the unassembled kit of furniture may be displayed for a first time period corresponding to the average assembler's assembly ability for assembling a portion of the unassembled kit of furniture according to the first step. A 3D animated transition may be displayed between the first step and a 3D animated second step for assembly of the unassembled kit of furniture. The 3D animated second step for assembly of the unassembled kit of furniture may be displayed for a second time period corresponding to the average assembler's assembly ability for assembling a portion of the unassembled kit of furniture according to the second step.

In one aspect, the inventory of parts may be displayed at an actual or near-to-actual size of an inventory of actual parts of the unassembled kit of furniture.

In one aspect, the inventory of parts may be displayed to scale or near-to-scale size in relation to other parts of the unassembled kit of furniture

In another aspect, the average assembler may input a screen size of the electronic display for determining the actual or near-to-actual size of the inventory of actual parts of the unassembled kit of furniture.

In another aspect, the average assembler may input a screen size of the electronic display for determining the scale or near-to-scale size of the parts of the unassembled kit of furniture

In another aspect, displaying the animated first step for assembly of the unassembled kit of furniture may include displaying at least one first part of the unassembled kit of furniture moveably engaging with at least one second part of the unassembled kit of furniture.

In another aspect, displaying the animated first step for assembly of the unassembled kit of furniture further may include animating at least one tool for moveably engaging the at least one part of the unassembled kit of furniture with the at least one second part of the unassembled kit of furniture.

In another aspect, at least one of the first and second time periods may be adjusted according to an input by the average assembler for indicating at least one power tool will be used.

In another aspect, a computer readable medium may be provided having instructions implemented as software code, which when executed by a processor causes the processor to perform the method described above.

These and other embodiments of the invention are described in further detail below with reference to the following figures.

### BRIEF DESCRIPTION OF THE DRAWINGS

FIG. 1 shows a schematic layout of a system for providing animated assembly instructions for assembling a kit of furniture, according to an embodiment of the invention.

FIG. 2 shows a flow chart of a method for implementing animated assembly instructions for assembling a kit of furniture, according to an embodiment of the invention.

FIGS. 3A-3H show an exemplary progression of screen shots of animated assembly instructions for assembling a kit of furniture, according to an embodiment of the invention.

FIG. 4 shows a flow chart of a method for creating animated assembly instructions for assembling a kit of furniture, according to an embodiment of the invention.

FIG. 5 is a high level block diagram of a computer apparatus, which can be configured for use with the systems and method disclosed herein.

### DETAILED DESCRIPTION OF THE INVENTION

A system and method are disclosed for providing animated instructions for assembling furniture. The parts required for assembling the furniture are presented on a display screen in a 3D format so that no reading is required to inventory the parts. Steps for assembling the furniture are then displayed in an animated 3D format, where the parts are moved and engaged as an actual assembler would place and view them. Tools are also made to appear and move as an actual assembler would place and view them. The steps are displayed for time periods that correspond to assembly time periods of an assembler of average skill.

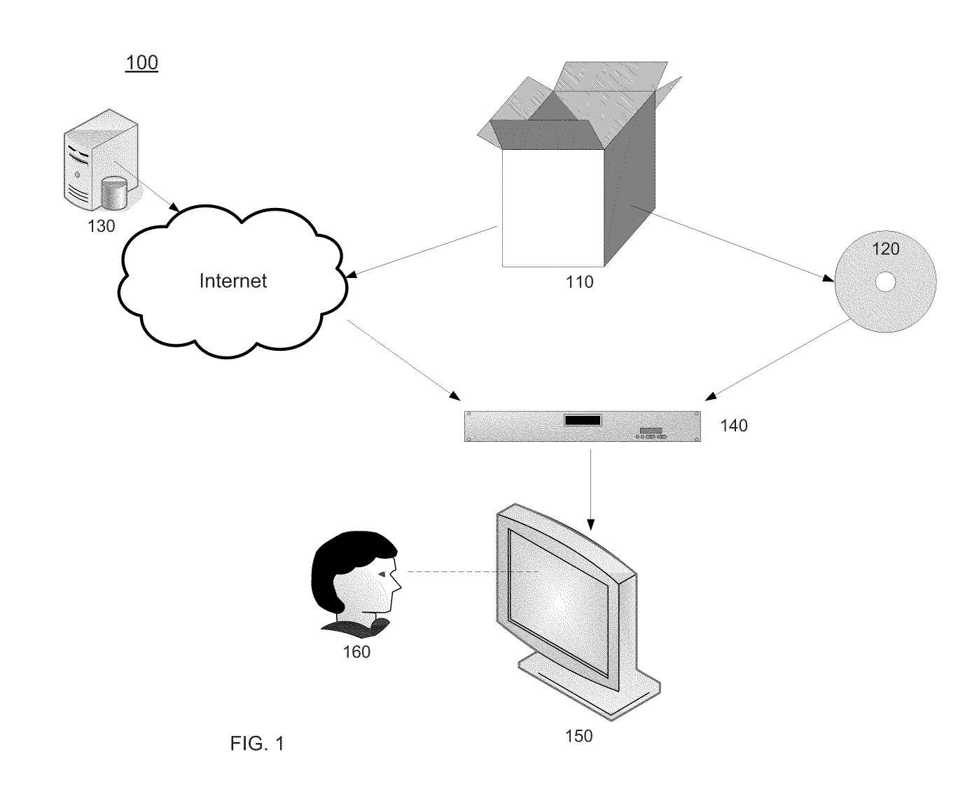

FIG. 1 shows a system 100 for providing instructions for assembling an unassembled kit of furniture, according to an embodiment of the invention. An unassembled kit 110 is provided that includes all parts required for assembling the unassembled kit 110 into furniture. For example, a desk kit would include a desk top, four legs, connecting pieces (e.g. screws, bolts, washers, etc.), and optionally tools. In one embodiment, the unassembled kit 110 may include an electronically readable medium 120 (e.g. DVD, CD-ROM, flash drive, etc.) that includes software that when executed displays animated instructions for assembling the unassembled kit. In another embodiment, the unassembled kit 110 includes directions (e.g. a URL to an Internet site) for connecting to a server computer 130 via the Internet for downloading or streaming the animated instructions.

The electronically readable medium 120 may be executed on a computer 130 for viewing on a display 150. The computer 130 may be a purpose-built display computer (e.g. DVD player, DVR player, video game console, streaming digital video player, etc.), general purpose computer, or a mobile communications device. The display 150 may be a purpose-built display (e.g. computer monitor) or a multipurpose display (e.g. television).

The computer 130 displays the animated instructions for assembling the unassembled kit on the display 150 by an assembler 160 of average skill. In one embodiment, the animated instructions are timed according to the assembly ability of the average skill of the assembler 160. For example, if an assembly step is determined to take five minutes for an average assembler to complete, that assembly step will be animated over a period of five minutes. Determining the display period of an assembly step can be determined statically, for example from recording the assembly times of a pool of assemblers.

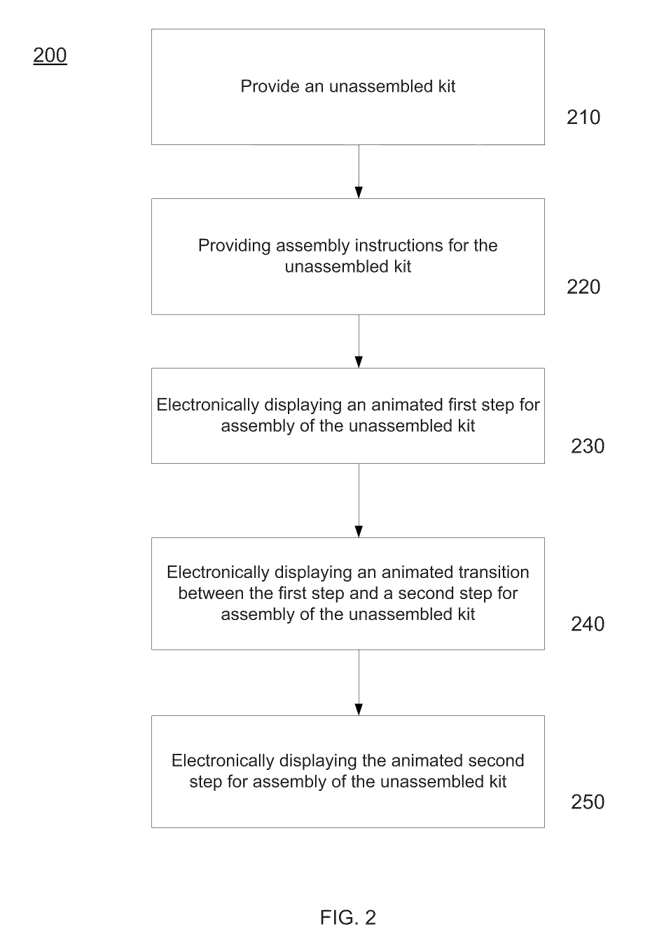

FIG. 2 shows a method 200 for assembling an unassembled kit of furniture 110, according to an embodiment of the invention. The method may be implemented on system 100. At operation 210, an average assembler 160 is provided with an unassembled kit of furniture 110. The unassembled kit of furniture 110 provides assembly instructions, in either a physical medium (e.g. DVD) or a streaming medium via an Internet address, which are executed by a computer 140 for viewing on a display 150 to the average assembler 160.

The assembly instructions may be configured to initially display a complete inventory of the actual parts of the unassembled kit of furniture. In one embodiment, the assembly instructions may be configured to display the parts of the unassembled kit of furniture 110 in the same or near-to-actual size of the actual parts of the unassembled kit of furniture 110. In a further embodiment, the instructions detect the display size of the display coupled to the computer and accordingly size the displayed parts in actual or near-to-actual sizes of the actual parts. Simple symbols (e.g., letters and/or numbers) may be displayed next to the parts of the unassembled kit of furniture 110 for future reference.

In an another embodiment, the assembly instructions may be configured to display the parts of the unassembled kit of furniture 110 in scale or near-to-scale size of the actual parts of the unassembled kit of furniture 110. For example, the assembly instructions may be configured to display a part of the unassembled kit of furniture 110 next to another part of the unassembled kit of furniture 110, or next to an incremented ruler, in a 1:1 scale. In a further embodiment, the instructions detect the display size of the display coupled to the computer and accordingly size the displayed parts to scale or near-to-scale when compared to other actual parts.

In yet another embodiment, the instructions are configured to query the average assembler to enter an option or input of the screen size of the display being viewed (e.g. 19″, 24″, 42″, etc.), and accordingly present the displayed parts in actual or near-to-actual sizes of the actual parts. Thus, the average assembler 160 may position the actual parts of the unassembled kit of furniture 110 next to the displayed parts in order to sort and determine that the proper actual parts have been provided along with the unassembled kit 110. The instructions may implement this embodiment as an interactive feature which a user can input screen options via an interface (e.g., remote control, keyboard). For example, an options screen may be presented to the user which displays selectable common screen sizes (e.g. 19″, 24″, 42″, etc.) and/or screen resolution (e.g., 800×600, 1024×768, etc.), or a manual input screen may be presented. The instructions may then use the screen size and/or resolution inputs to calculate the appropriate pixel scale such that the viewed parts are presented in actual or near-to-actual sizes views of the actual parts. In some embodiments, the instructions detect and scale the displayed parts to actual or near-to-actual sizes without requiring a related user action. Some smaller and larger displays may not be appropriate for displaying viewed parts in actual or near-to-actual sizes, and thus may display viewed parts according to a default scaled view. “Near-to” as used herein is intended to mean that a displayed part is sized such that the average assembler would be able to easily discern a correct actual part next to the displayed part. The assembly instructions may also be configured to display the tools supplied or required by the average assembler to supply for assembly of the unassembled kit of furniture.

In yet another embodiment, the instructions are configured to query the average assembler to enter an option or input of the screen size of the display being viewed (e.g. 19″, 24″, 42″, etc.), and accordingly present the displayed parts scaled or near-to-scale sizes of the actual parts in an optimal viewing size. Thus, the average assembler 160 may compare the scale the actual parts of the unassembled kit of furniture 110 next to the scale of other parts in order to sort and determine that the proper actual parts have been provided along with the unassembled kit 110. The instructions may implement this embodiment as an interactive feature which a user can input screen options via an interface (e.g., remote control, keyboard). For example, an options screen may be presented to the user which displays selectable common screen sizes (e.g. 19″, 24″, 42″, etc.) and/or screen resolution (e.g., 800×600, 1024×768, etc.), or a manual input screen may be presented. The instructions may then use the screen size and/or resolution inputs to calculate the appropriate pixel scale such that the viewed parts are presented in appropriate sized scaled or near-to-scale views of the actual parts. In some embodiments, the instructions detect and scale the displayed parts without requiring a related user action.

At operation 230, a first step for assembly of the unassembled kit of furniture is animated on the display. The first step may be initiated by an input to the computer by the average assembler, after the inventory of the actual parts has been displayed. The first step may initially display at least one first part to be assembled during the first step. A simple symbol (e.g., letter and/or number) may be animatedly (e.g., faded in and out) displayed next to the at least one first part for reference from the previous inventory view. The at least one first part may be displayed in an animated 3D format, and may be moveably animated using zooming and panning techniques in order to display multiple views of the at least one first part. In one embodiment, the at least one first part is positioned in a view which corresponds to the view of the average assembler 160 as required for assembling the corresponding actual part. At least one second part may be displayed with or after the presentation of the at least one first part. The at least one second part may be animated to moveably engage with the at least one first part. Connecting pieces that connect the at least one first part and the at least one second part may also be moveably animated in various views. At least one tool that is used for connecting the at least one first part and the at least one second part may also be displayed and moveably animated in various views.

The first step for assembly of the unassembled kit of furniture is displayed according to a time period corresponding to the assembly ability of the average assembler 160 to complete the first step. For example, if the average assembler 160 takes five minutes to complete the first step, then the first step is displayed for five minutes. Sub-intervals of the first step are also displayed according to the average assembler's assembly. For example, if the average assembler 160 takes one minute to bolt a connecting piece, the animation of that connecting piece will be displayed for one minute. Inputs may be given by the average assembler 160 to the computer 140 to account for the use of at least one power tool, and thus the time period will shorten accordingly. The average assembler may also pause, fast forward, or reverse the time period using the controls of the computer. At the end of the first step, the at least one first part and the at least one second part will be displayed in an assembled state.

At operation 240, a transition is animated between the first step and the second step. The transition may include displaying of a numerical or textual indicator (e.g. STEP 2). The assembled at least one first part and the at least one second part are then smoothly animated (e.g. by panning, rotating, zooming, etc.) into a new position, and/or one or more new parts may be displayed for animating a second step for assembly in operation 250. The method will continue in a required number of steps to complete the assembly of the unassembled kit of furniture 110 in a similar fashion.

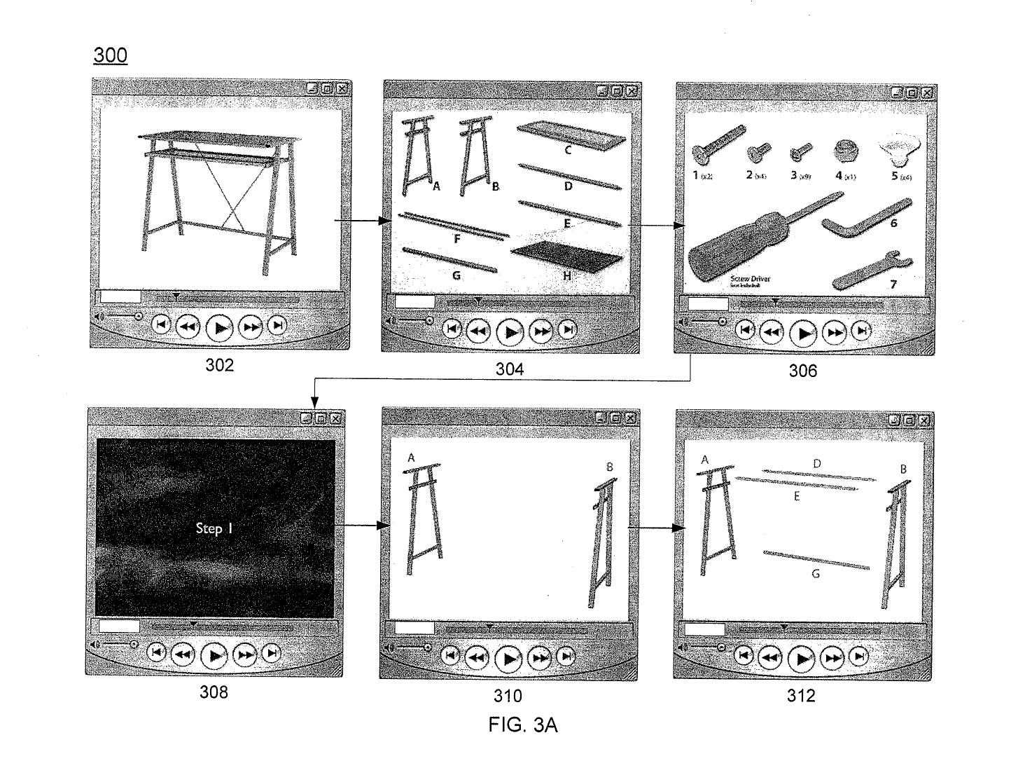

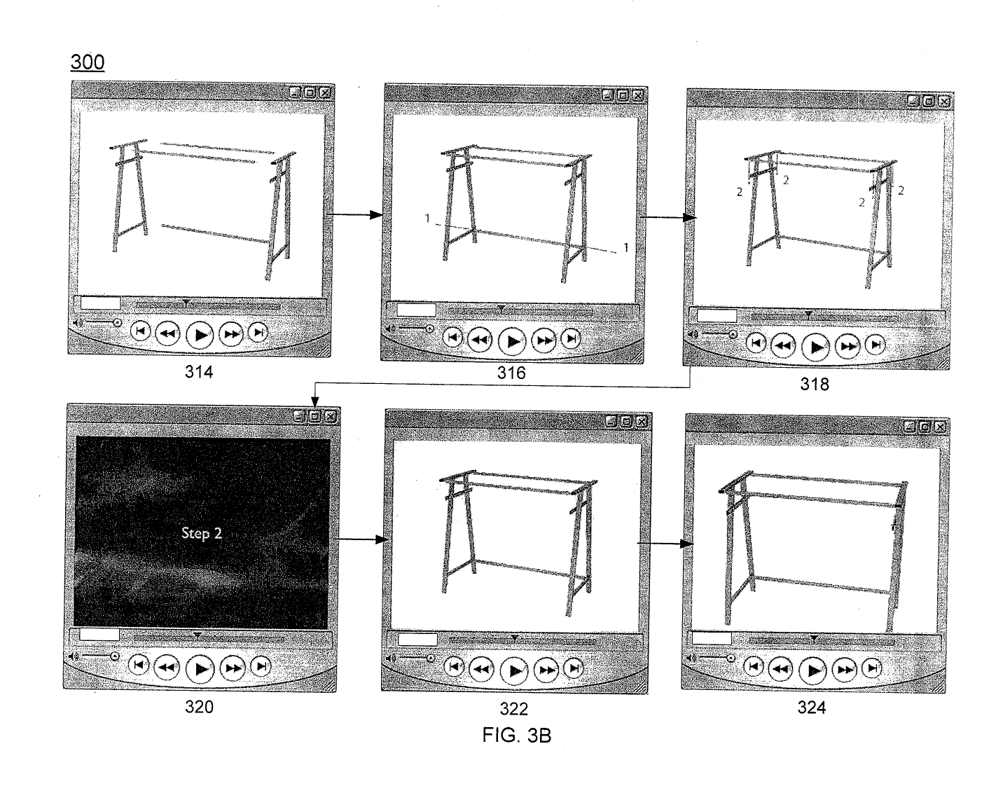

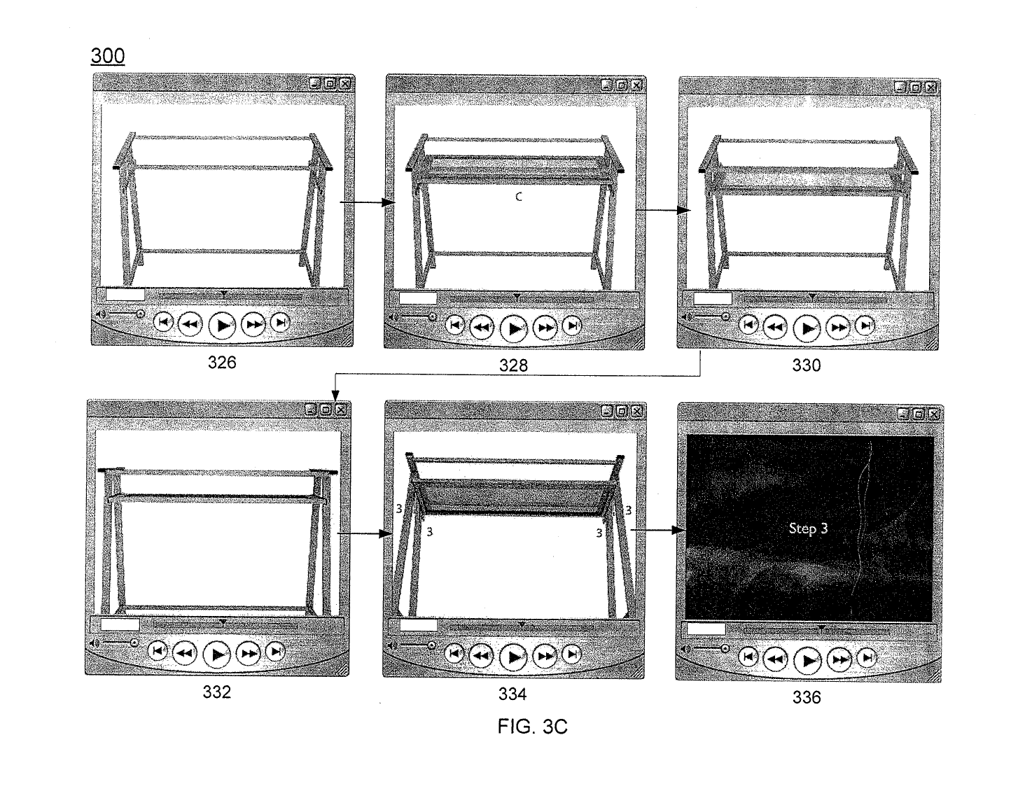

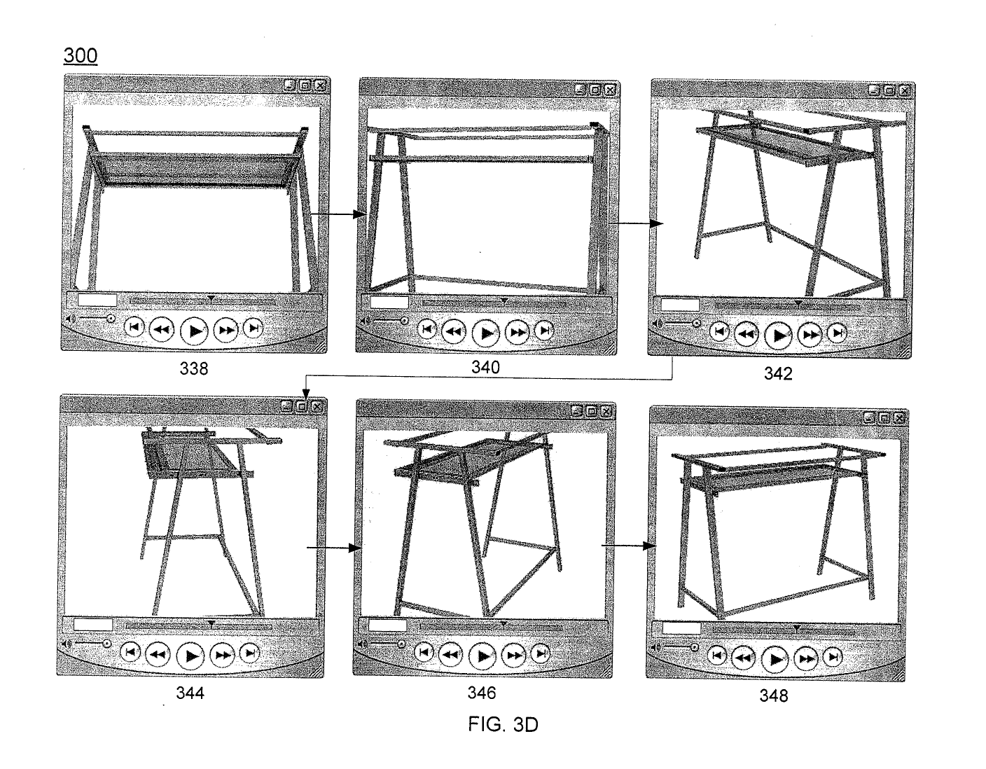

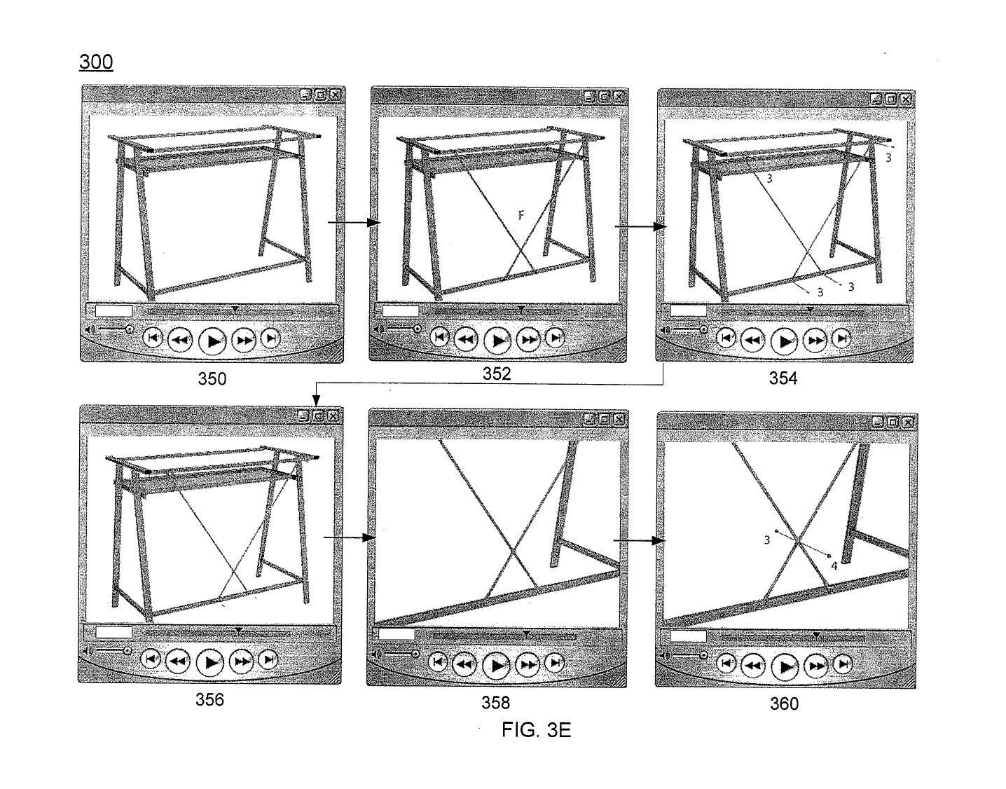

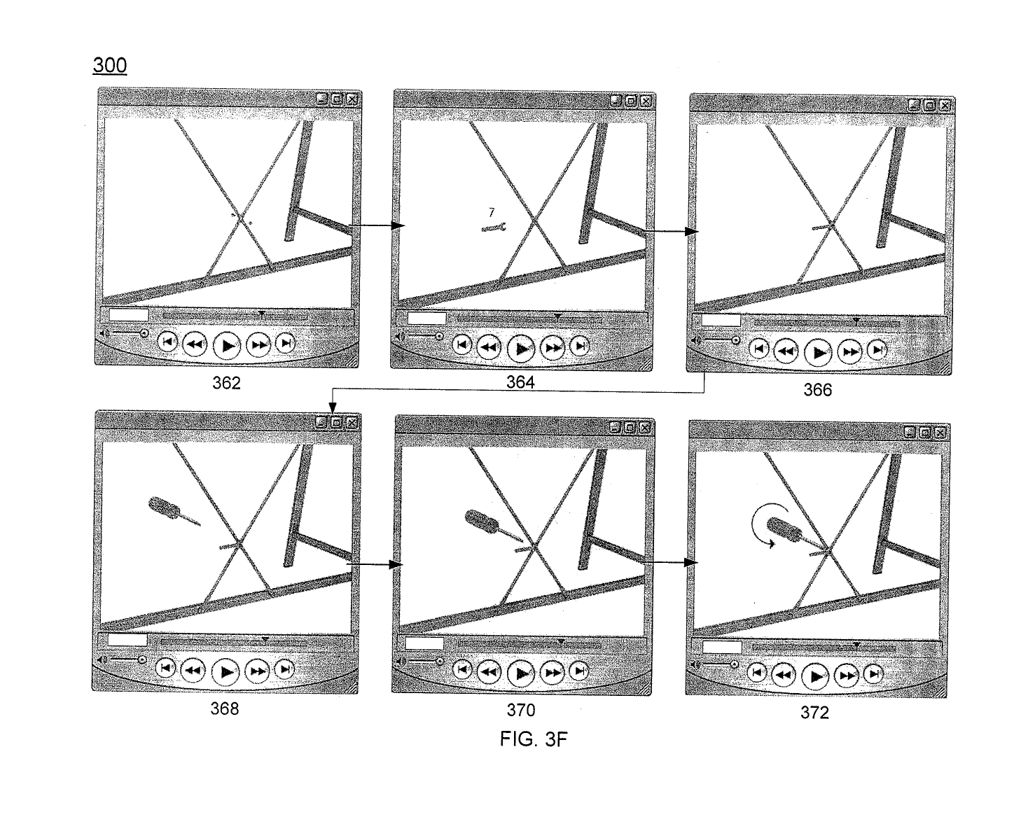

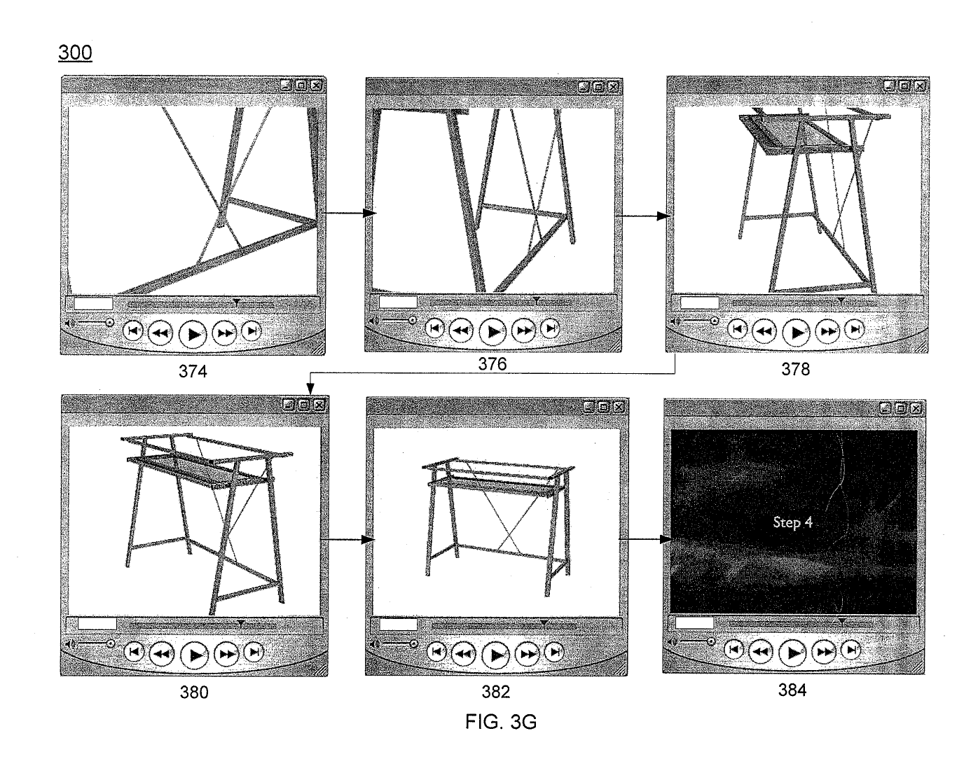

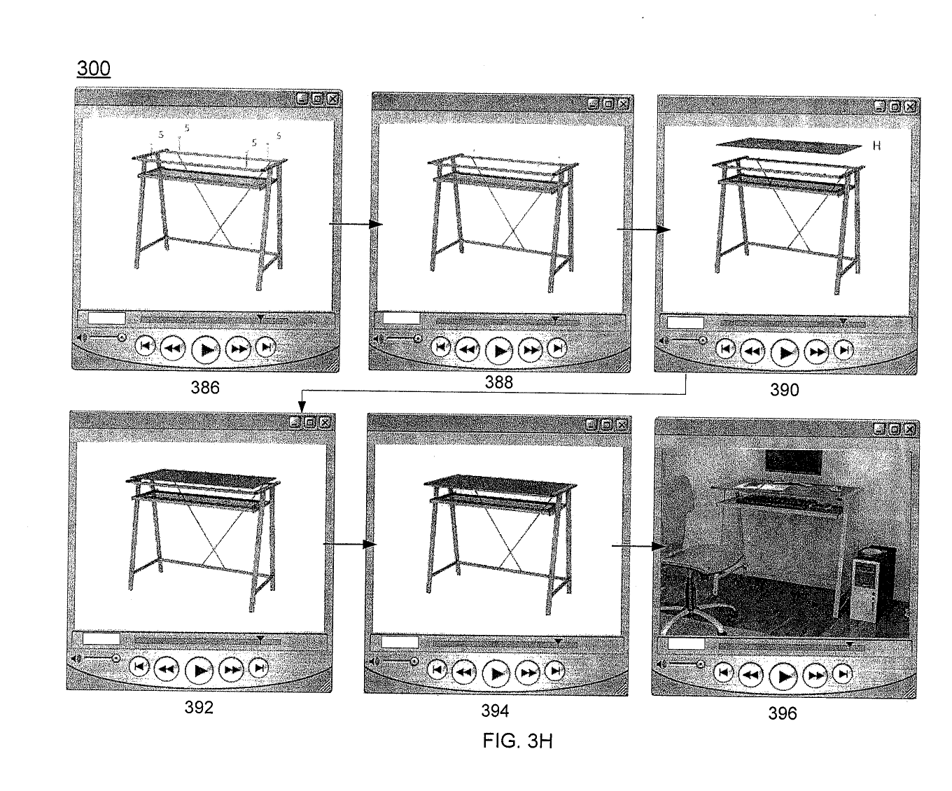

FIGS. 3A-3H show an exemplary progression of screen shots of an assembly video, according to an embodiment of the invention. Screenshot 302 shows a completed view of a desk to be assembled from an unassembled kit. Screenshot 302 smoothly transitions (e.g. by fading in and out) into screen shot 304, which displays an inventory of the main portions of the unassembled kit. Screenshot 304 smoothly transitions into screenshot 306, which displays an inventory of connecting pieces and tools included with the unassembled kit. The connecting pieces may be displayed in actual or near-to-actual sizes of the actual connecting pieces, or scale (e.g., 1:1) or near-to-scale sizes of the actual connecting pieces.

Screenshot 306 smoothly fades into screenshot 308, which displays a transitional screen indicating beginning of Step 1 of assembly. Screenshot 308 smoothly transitions into screenshot 310, which displays legs A and B of the desk. Screenshot 310 fades in crossbars D, E and G and places them in relation to how they connect legs A and B. Screenshot 314 fades out the part indicators and animatedly moves the legs A and B towards the crossbars D, E and G. Screenshot 316 halts the movement of the legs A and B when the crossbars D, E and G come into contact, and fades in screws 1 and animatedly engages the screws (i.e. with rotation and longitudinal movement) into the bottom crossbar G. Screenshot 318 fades in screws 2 and animatedly engages the screws into the bottom crossbar G. Step 1 is displayed according to a time period for that an average assembler requires for completing the step.

Screenshot 318 smoothly fades into screenshot 320, which displays a transitional screen indicating the beginning of the Step 2 of assembly. Screenshot 320 smoothly fades into screenshot 322, which displays the partially assembled desk after the completion of Step 1. Screenshot 324 begins the rotation of the partially assembled desk, which is halted in screenshot 326. Screenshot 328 fades in keyboard tray C, and animatedly lowers it into a resting position in screenshot 330. The desk is further rotated between screenshots 330, 332 and 334. In screen shot 334, the rotation is halted and screws 3 fade in and are animatedly engaged into the desk to attach the keyboard tray C thereto. Step 2 is displayed according to a time period that an average assembler requires for completing the step.

Screenshot 334 smoothly fades into screenshot 336, which displays a transitional screen indicating the beginning of the Step 3 of assembly. The view of previous screenshot 334 is faded into view in screenshot 338. The desk is then animatedly rotated between screenshots 338 and 350 where the rotation is halted. In screenshot 352, cross members F are faded into view. In screenshots 354 and 356, screws 4 are faded in and animatedly engaged into the desk to connect the cross members F to the desk. An area where the cross members F cross one another is then animatedly zoomed in between screenshots 356 and 358. In screenshot 360, a screw 3 and a nut 4 are faded into view, and then partially moveably engaged in screenshot 362. In screenshot 364, wrench 7 is faded into view and moved to engage the nut 4 in screenshot 366. In screenshot 368, a screwdriver is faded into view and moved towards the screw 3 in screenshot 370. In screenshot 372, the screwdriver is moveably animated (i.e. rotated) to fully engage the screw 3 and nut 4 together. The view of the desk is then zoomed out and rotated between screenshots 374 and 382. Step 3 is displayed according to a time period that an average assembler requires for completing the step.

Screenshot 382 smoothly fades into screenshot 384, which displays a transitional screen indicating the beginning of the Step 4 of assembly. The view of previous screenshot 382 is faded into view in screenshot 386 and bumpers 5 are faded into view. The bumpers 5 are then moveably engaged (i.e. plugged into holes) into the desk in screenshot 388. A glass desktop H is then faded into view in screenshot 390 and lowered onto the bumpers between screenshots 390 and 394. The final resting position of the desk is maintained between screenshots 394 and 396, where a real-life (i.e. photorealistic) depiction of the desk is faded into view to demonstrate the completion of the assembly. Step 4 is displayed according to a time period that an average assembler requires for completing the step.

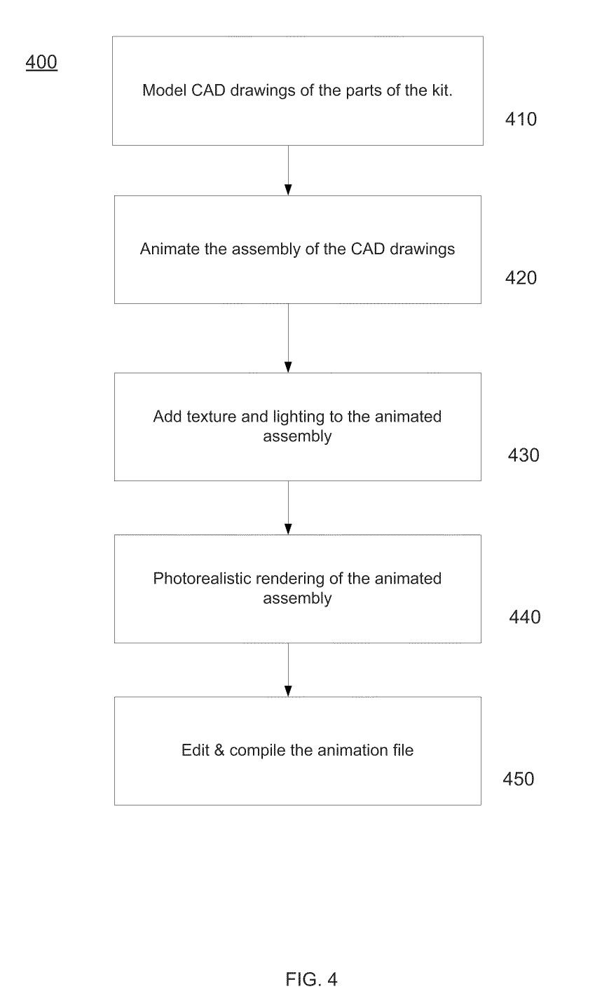

FIG. 4 shows a method 400 for creating animated assembly video, according to an embodiment of the invention. At operation 410, 3D computer animated design (CAD) models are created or imported for all parts of an unassembled kit. At operation 420, the 3D CAD models of the parts are animated into assembly steps. At operation 430, texture and lighting is added to the animated assembly steps. At operation 440, all or a portion of the animated assembly steps are rendered into photorealistic views. At operation 450, editing is performed to add music if desired and compile the completed animation file. Commercially available animation software, such as Autodesk® 3Ds Max® by Autodesk, Inc., may be used to implement method 400.

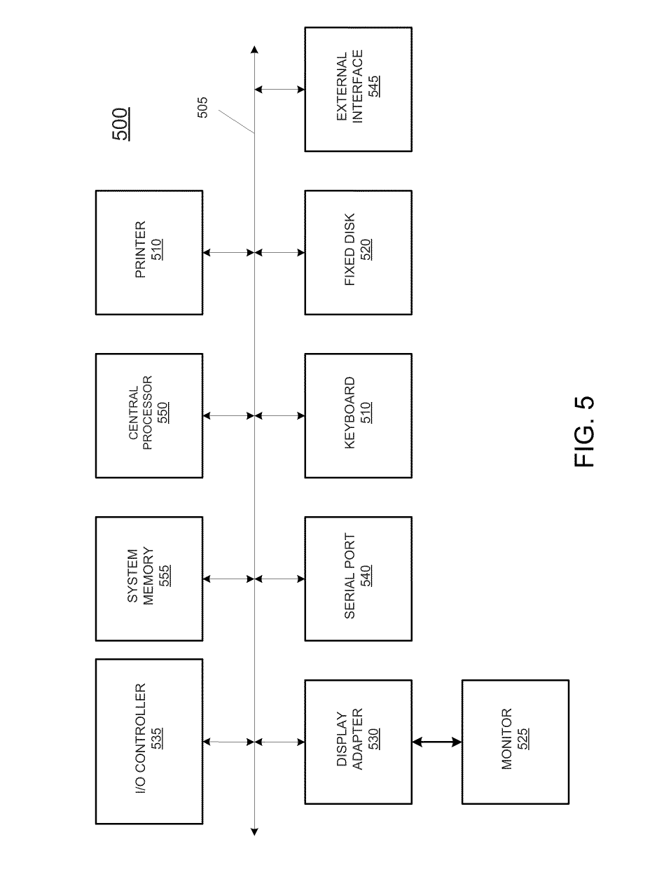

FIG. 5 is a high level block diagram of a computer apparatus 500 that may be used to implement any of the methods or systems (e.g. server computer 130, computer 140, etc.) described above, which may include one or more of the subsystems or components shown in FIG. 5. The subsystems shown in FIG. 5 are interconnected via a system bus 505. Additional subsystems such as a printer 510, keyboard/remote control 515, fixed disk 520, monitor/television 525, which is coupled to display adapter 530, and others are shown. Peripherals and input/output (I/O) devices, which couple to an I/O controller 535, can be connected to the computer apparatus 500 by any number of means known in the art, such as serial port 540. For example, the serial port 540 or external interface 545 can be used to connect the computer apparatus 500 to a wide area network such as the Internet, a mouse input device, or a scanner. The interconnection via the system bus 505 allows the central processor 550 to communicate with each subsystem and to control the execution of instructions from system memory 555 or the fixed disk 520, as well as the exchange of information between subsystems. The system memory 555 and/or the fixed disk 520 may embody a computer readable medium.

It should be understood that the present invention as described above can be implemented in the form of control logic using computer software in a modular or integrated manner. Based on the disclosure and teachings provided herein, a person of ordinary skill in the art can know and appreciate other ways and/or methods to implement the present invention using hardware and a combination of hardware and software.

Any of the software components, user interfaces, or methods described in this application may be implemented as software code to be executed by a processor using any suitable computer language such as, for example, Java, C++ or Perl using, for example, conventional or object-oriented techniques. The software code may be stored as a series of instructions or commands on a computer readable medium, such as a random access memory (RAM), a read-only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method for assembling furniture provided in an unassembled kit, the method comprising:
displaying a 3D inventory of parts of an unassembled kit of furniture from assembly instructions on an electronic display, the unassembled kit of furniture and assembly instructions being provided to an average assembler;
displaying a 3D animated first step for assembly of the unassembled kit of furniture for a first time period corresponding to the average assembler's assembly ability for assembling a portion of the unassembled kit of furniture according to the first step;
displaying a 3D animated transition between the first step and a 3D animated second step for assembly of the unassembled kit of furniture; and
displaying the 3D animated second step for assembly of the unassembled kit of furniture for a second time period corresponding to the average assembler's assembly ability for assembling a portion of the unassembled kit of furniture according to the second step.

2. The method of claim 1, wherein the inventory of parts is displayed at an actual or near-to-actual size of an inventory of actual parts of the unassembled kit of furniture.

3. The method of claim 2, wherein the average assembler inputs a screen size of the electronic display for determining the actual or near-to-actual size of the inventory of actual parts of the unassembled kit of furniture.

4. The method of claim 1, wherein the inventory of parts is displayed in scale or near-to-scale size compared to actual parts of the unassembled kit of furniture.

5. The method of claim 4, wherein the average assembler inputs a screen size of the electronic display for determining the scale or near-to-scale size of the inventory of actual parts of the unassembled kit of furniture.

6. The method of claim 1, wherein displaying the animated first step for assembly of the unassembled kit of furniture comprises displaying at least one first part of the unassembled kit of furniture moveably engaging with at least one second part of the unassembled kit of furniture.

7. The method of claim 6, wherein displaying the animated first step for assembly of the unassembled kit of furniture further comprises animating at least one tool for moveably engaging the at least one part of the unassembled kit of furniture with the at least one second part of the unassembled kit of furniture.

8. The method of claim 1, wherein at least one of the first and second time periods is adjusted according to an input by the average assembler for indicating that at least one power tool will be used.

9. A computer readable medium having instructions implemented as software code, that when executed by a processor causes the processor to perform the method of claim 1.
